(19) United States
(12) Patent Application Publication
(10) Pub. No.: US 2026/0301656 A1
(43) Pub. Date: Oct. 1, 2026

(54) PIXEL CIRCUIT AND DISPLAY DEVICE

(71) Applicant: BOE TECHNOLOGY GROUP CO., LTD., Beijing (CN)

(72) Inventors: Zhenyu Zhang, Beijing (CN); Minghua Xuan, Beijing (CN); Xuan Feng, Beijing (CN)

(73) Assignee: BOE TECHNOLOGY GROUP CO., LTD., Beijing (CN)

(21) Appl. No.: 19/489,340

(22) PCT Filed: May 22, 2024
(86) PCT No.: PCT/CN2024/094578

§ 371 Date: Dec. 2, 2025

(30) Foreign Application Priority Data
Jun. 21, 2023 (CN) 202310745958.2

(51) Int. Cl. G09G 3/32; G09G 3/3233

(52) U.S. Cl. CPC G09G 3/32; G09G 3/3233; G09G 2300/0819; G09G 2300/0852; G09G 2320/0214; G09G 2320/0247; G09G 2320/045; G09G 2330/021

(57) ABSTRACT

A pixel circuit and a display device are provided. The pixel circuit includes a driving circuit, a light-emitting element and a first light-emission control circuit. The driving circuit is electrically coupled to a first electrode of the light-emitting element, and the driving circuit is configured to generate a driving current for driving the light-emitting element under the control of a potential at a control end of the driving circuit; the first light-emission control circuit is electrically coupled to a first light-emission control end, a second electrode of the light-emitting element and a first voltage end, and configured to control the second electrode of the light-emitting element to be electrically coupled to the first voltage end under the control of a first light-emission control signal; and a source electrode of a transistor included in the first light-emission control circuit is electrically coupled to the first voltage end.

### CROSS-REFERENCE TO RELATED APPLICATION

This application claims a priority of the Chinese patent application No. 202310745958.2 filed on Jun. 21, 2023, which is incorporated herein by reference in its entirety.

### TECHNICAL FIELD

The present disclosure relates to the field of display technology, in particular to a pixel circuit and a display device.

### BACKGROUND

In a conventional pixel circuit, a first light-emission control circuit is arranged between a light-emitting element and a driving circuit, and a voltage applied to a source electrode of a transistor included in the first light-emission control circuit is variable, so a signal applied to a gate electrode of the transistor included in the first light-emission control circuit needs a relatively large voltage difference, and thereby there is a high risk of signal crosstalk.

### SUMMARY

A main object of the present disclosure is to provide a pixel circuit and a display device, so as to solve the problem in a conventional pixel circuit where the signal applied to the gate electrode of the transistor included in the first light-emission control circuit needs a relatively large voltage difference and thereby there is a high risk of signal crosstalk.

In one aspect, the present disclosure provides in some embodiments a pixel circuit, including a driving circuit, a light-emitting element and a first light-emission control circuit. The driving circuit is electrically coupled to a first electrode of the light-emitting element, and the driving circuit is configured to generate a driving current for driving the light-emitting element under the control of a potential at a control end of the driving circuit; the first light-emission control circuit is electrically coupled to a first light-emission control end, a second electrode of the light-emitting element and a first voltage end, and configured to control the second electrode of the light-emitting element to be electrically coupled to the first voltage end under the control of a first light-emission control signal provided by the first light-emission control end; and a source electrode of a transistor included in the first light-emission control circuit is electrically coupled to the first voltage end.

Optionally, the pixel circuit further includes a second light-emission control circuit; the second light-emission control circuit is electrically coupled to a second light-emission control end, a second voltage end and a first end of the driving circuit, and configured to control the second voltage end to be electrically coupled to the first end of the driving circuit under the control of a second light-emission control signal provided by the second light-emission control end; a source electrode of a transistor included in the second light-emission control circuit is electrically coupled to the second voltage end; and a second end of the driving circuit is electrically coupled to the first electrode of the light-emitting element.

Optionally, the first light-emission control circuit includes a first transistor; a gate electrode of the first transistor is electrically coupled to the first light-emission control end, a first electrode of the first transistor is electrically coupled to the second electrode of the light-emitting element, and a second electrode of the first transistor is electrically coupled to the first voltage end; and the first transistor is an n-type transistor.

Optionally, the second light-emission control circuit includes a second transistor; a gate electrode of the second transistor is electrically coupled to the second light-emission control end, a first electrode of the second transistor is electrically coupled to the second voltage end, and a second electrode of the second transistor is electrically coupled to the first end of the driving circuit; and the second transistor is a p-type transistor.

Optionally, the pixel circuit further includes a third light-emission control circuit; the third light-emission control circuit is electrically coupled to the first light-emission control end, a first data line, a first write-in control end, a third voltage end, a fourth voltage end, a first light-emission control voltage end and a second light-emission control voltage end, and configured to write a first data voltage provided by the first data line into a first light-emission control node under the control of a first write-in control signal provided by the first write-in control end, maintain a potential at the first light-emission control node, and control the first light-emission control end to be electrically coupled to the first light-emission control voltage end or the second light-emission control voltage end under the control of the first data voltage.

Optionally, the third light-emission control circuit includes a first write-in control circuit, a first control circuit, a second control circuit and a first energy storage circuit; the first write-in control circuit is electrically coupled to the first write-in control end, the first data line and the first light-emission control node, and configured to write the first data voltage into the first light-emission control node under the control of the first write-in control signal; the first energy storage circuit is electrically coupled to the first light-emission control node, and configured to maintain the potential at the first light-emission control node; the first control circuit is electrically coupled to the first light-emission control node, the third voltage end, the fourth voltage end and a second light-emission control node, and configured to control the second light-emission control node to be electrically coupled to the third voltage end or the fourth voltage end under the control of the potential at the first light-emission control node; and the second control circuit is electrically coupled to the second light-emission control node, the first light-emission control end, the first light-emission control voltage end and the second light-emission control voltage end, and configured to control the first light-emission control end to be electrically coupled to the first light-emission control voltage end or the second light-emission control voltage end under the control of a potential at the second light-emission control node.

Optionally, the first write-in control circuit includes a third transistor, the first control circuit includes a fourth transistor and a fifth transistor, the second control circuit includes a sixth transistor and a seventh transistor, and the first energy storage circuit includes a first capacitor; a gate electrode of the third transistor is electrically coupled to the first write-in control end, a first electrode of the third transistor is electrically coupled to the first data line, and a second electrode of the third transistor is electrically coupled to the first light-emission control node; a gate electrode of the fourth transistor is electrically coupled to the first light-emission control node, a first electrode of the fourth transistor is electrically coupled to the third voltage end, and a second electrode of the fourth transistor is electrically coupled to the second light-emission control node; a gate electrode of the fifth transistor is electrically coupled to the first light-emission control node, a first electrode of the fifth transistor is electrically coupled to the fourth voltage end, and a second electrode of the fifth transistor is electrically coupled to the second light-emission control node; a gate electrode of the sixth transistor is electrically coupled to the second light-emission control node, a first electrode of the sixth transistor is electrically coupled to the first light-emission control voltage end, and a second electrode of the sixth transistor is electrically coupled to the first light-emission control end; a gate electrode of the seventh transistor is electrically coupled to the second light-emission control node, a first electrode of the seventh transistor is electrically coupled to the second light-emission control voltage end, and a second electrode of the seventh transistor is electrically coupled to the first light-emission control end; and a first end of the first capacitor is electrically coupled to the first light-emission control node, and a second end of the first capacitor is electrically coupled to a first initial voltage end.

Optionally, the pixel circuit further includes a fourth light-emission control circuit; the fourth light-emission control circuit is electrically coupled to the second light-emission control end, a first data line, a first write-in control end, a third voltage end, a fourth voltage end, a first light-emission control voltage end and a second light-emission control voltage end, and configured to write a first data voltage provided by the first data line into a first light-emission control node under the control of a first write-in control signal provided by the first write-in control end, maintain a potential at the first light-emission control node, and control the second light-emission control end to be electrically coupled to the first light-emission control voltage end or the second light-emission control voltage end under the control of the first data voltage.

Optionally, the fourth light-emission control circuit includes a first write-in control circuit, a first control circuit, a second control circuit and a first energy storage circuit; the first write-in control circuit is electrically coupled to the first write-in control end, the first data line and the first light-emission control node, and configured to write the first data voltage into the first light-emission control node under the control of the first write-in control signal; the first energy storage circuit is electrically coupled to the first light-emission control node, and configured to maintain the potential at the first light-emission control node; the first control circuit is electrically coupled to the first light-emission control node, the third voltage end, the fourth voltage end and a second light-emission control node, and configured to control the second light-emission control node to be electrically coupled to the third voltage end or the fourth voltage end under the control of the potential at the first light-emission control node; and the second control circuit is electrically coupled to the second light-emission control node, the second light-emission control end, the first light-emission control voltage end and the second light-emission control voltage end, and configured to control the second light-emission control end to be electrically coupled to the first light-emission control voltage end or the second light-emission control voltage end under the control of a potential at the second light-emission control node.

Optionally, the first write-in control circuit includes a third transistor, the first control circuit includes a fourth transistor and a fifth transistor, the second control circuit includes a sixth transistor and a seventh transistor, and the first energy storage circuit includes a first capacitor; a gate electrode of the third transistor is electrically coupled to the first write-in control end, a first electrode of the third transistor is electrically coupled to the first data line, and a second electrode of the third transistor is electrically coupled to the first light-emission control node; a gate electrode of the fourth transistor is electrically coupled to the first light-emission control node, a first electrode of the fourth transistor is electrically coupled to the third voltage end, and a second electrode of the fourth transistor is electrically coupled to the second light-emission control node; a gate electrode of the fifth transistor is electrically coupled to the first light-emission control node, a first electrode of the fifth transistor is electrically coupled to the fourth voltage end, and a second electrode of the fifth transistor is electrically coupled to the second light-emission control node; a gate electrode of the sixth transistor is electrically coupled to the second light-emission control node, a first electrode of the sixth transistor is electrically coupled to the first light-emission control voltage end, and a second electrode of the sixth transistor is electrically coupled to the second light-emission control end; a gate electrode of the seventh transistor is electrically coupled to the second light-emission control node, a first electrode of the seventh transistor is electrically coupled to the second light-emission control voltage end, and a second electrode of the seventh transistor is electrically coupled to the second light-emission control end; and a first end of the first capacitor is electrically coupled to the first light-emission control node, and a second end of the first capacitor is electrically coupled to a first initial voltage end.

Optionally, the pixel circuit further includes a first resetting circuit; and the first resetting circuit is electrically coupled to a first resetting end, the first electrode of the light-emitting element and the second electrode of the light-emitting element, and configured to control the first electrode of the light-emitting element to be electrically coupled to the second electrode of the light-emitting element under the control of a first resetting signal provided by the first resetting end.

Optionally, the first resetting circuit includes an eighth transistor; and a gate electrode of the eighth transistor is electrically coupled to the first resetting end, a first electrode of the eighth transistor is electrically coupled to the first electrode of the light-emitting element, and a second electrode of the eighth transistor is electrically coupled to the second electrode of the light-emitting element.

Optionally, the pixel circuit further includes a second energy storage circuit, a second write-in control circuit, a compensation control circuit and a second resetting circuit; the second energy storage circuit is electrically coupled to the control end of the driving circuit, and configured to store electric energy; the second write-in control circuit is electrically coupled to a second write-in control end, a second data line and the first end of the driving circuit, and configured to write a second data voltage provided by the second data line into the first end of the driving circuit under the control of a second write-in control signal provided by the second write-in control end; the compensation control circuit is electrically coupled to a compensation control end, the control end of the driving circuit and the second end of the driving circuit, and configured to control the control end of the driving circuit to be electrically coupled to the second end of the driving circuit under the control of a compensation control signal provided by the compensation control end; and the second resetting circuit is electrically coupled to a second resetting end, a second initial voltage end and the control end of the driving circuit, and configured to write a second initial voltage provided by the second initial voltage end into the control end of the driving circuit under the control of a second resetting signal provided by the second resetting end.

Optionally, the second energy storage circuit includes a second capacitor, the second write-in circuit control circuit includes a ninth transistor, the compensation control circuit includes a tenth transistor, the second resetting circuit includes an eleventh transistor, and the driving circuit includes a driving transistor; a first end of the second capacitor is electrically coupled to a gate electrode of the driving transistor, and a second end of the second capacitor is electrically coupled to the second voltage end; a gate electrode of the ninth transistor is electrically coupled to the second write-in control end, a first electrode of the ninth transistor is electrically coupled to the second data line, and a second electrode of the ninth transistor is electrically coupled to the first end of the driving circuit; a gate electrode of the tenth transistor is electrically coupled to the compensation control end, a first electrode of the tenth transistor is electrically coupled to the control end of the driving circuit, and a second electrode of the tenth transistor is electrically coupled to the second end of the driving circuit; a gate electrode of the eleventh transistor is electrically coupled to the second resetting end, a first electrode of the eleventh transistor is electrically coupled to the second initial voltage end, and a second electrode of the eleventh transistor is electrically coupled to the control end of the driving circuit; and the gate electrode of the driving transistor is electrically coupled to the control end of the driving circuit, a first electrode of the driving transistor is electrically coupled to the first end of the driving circuit, and a second electrode of the driving transistor is electrically coupled to the second end of the driving circuit.

In another aspect, the present disclosure provides in some embodiments a display device including the above-mentioned pixel circuit.

In the embodiments of the present disclosure, the first light-emission control circuit is arranged between the light-emitting element and the first voltage end, and a type of the transistor included in the first light-emission control circuit is set in such a manner that a source electrode of the transistor is electrically coupled to a direct-current voltage end (the first voltage end is the direct-current voltage end), so as to narrow a range of a voltage applied to a gate electrode of the transistor. An on state and an off state of the voltage applied to the gate electrode are set with a voltage of a first voltage signal provided by the first voltage end as a center, so as to reduce a risk of signal crosstalk.

### BRIEF DESCRIPTION OF THE DRAWINGS

FIG. 1 is a schematic view showing a pixel circuit according to an embodiment of the present disclosure;

FIG. 2 is a schematic view showing the pixel circuit according to at least one embodiment of the present disclosure;

FIG. 3 is a schematic view showing the pixel circuit according to at least one embodiment of the present disclosure;

FIG. 4 is a schematic view showing the pixel circuit according to at least one embodiment of the present disclosure;

FIG. 5 is a schematic view showing the pixel circuit according to at least one embodiment of the present disclosure;

FIG. 6 is a schematic view showing the pixel circuit according to at least one embodiment of the present disclosure;

FIG. 7 is a schematic view showing the pixel circuit according to at least one embodiment of the present disclosure;

FIG. 8 is a schematic view showing the pixel circuit according to at least one embodiment of the present disclosure;

FIG. 9 is a circuit diagram of the pixel circuit according to at least one embodiment of the present disclosure;

FIG. 10 is a sequence diagram of the pixel circuit in FIG. 9;

FIG. 11 is a circuit diagram of the pixel circuit according to at least one embodiment of the present disclosure;

FIG. 12 is a sequence diagram of the pixel circuit in FIG. 11;

FIG. 13 is a circuit diagram of the pixel circuit according to at least one embodiment of the present disclosure;

FIG. 14 is a sequence diagram of the pixel circuit in FIG. 13;

FIG. 15 is a circuit diagram of the pixel circuit according to at least one embodiment of the present disclosure; and

FIG. 16 is a sequence diagram of the pixel circuit in FIG. 15.

### DETAILED DESCRIPTION

The technical solutions of the present disclosure will be described hereinafter in a clear and complete manner in conjunction with the drawings and embodiments. Obviously, the following embodiments merely relate to a part of, rather than all of, the embodiments of the present disclosure, and based on these embodiments, a person skilled in the art may, without any creative effort, obtain the other embodiments, which also fall within the scope of the present disclosure.

All transistors adopted in the embodiments of the present disclosure may be thin film transistors, field effect transistors or any other elements having an identical characteristic. In order to differentiate two electrodes other than a gate electrode from each other, one of the two electrodes is called as first electrode and the other is called as second electrode.

In actual use, in a case that the transistor is a thin film transistor or field effect transistor, the first electrode may be a drain electrode and the second electrode may be a source electrode, or the first electrode may be a source electrode and the second electrode may be a drain electrode.

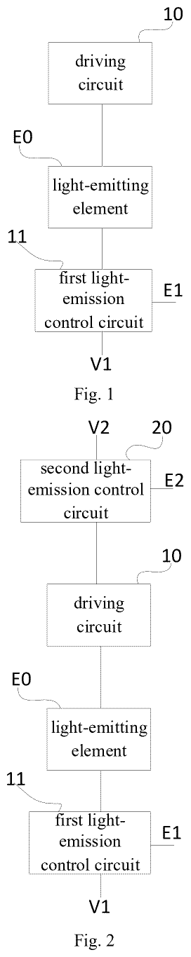

As shown in FIG. 1, the present disclosure provides in some embodiments a pixel circuit, which includes a driving circuit 10, a light-emitting element E0 and a first light-emission control circuit 11. The driving circuit 10 is electrically coupled to a first electrode of the light-emitting element E0, and the driving circuit 10 is configured to generate a driving current for driving the light-emitting element E0 under the control of a potential at a control end of the driving circuit; the first light-emission control circuit 11 is electrically coupled to a first light-emission control end E1, a second electrode of the light-emitting element E0 and a first voltage end V1, and configured to control the second electrode of the light-emitting element E0 to be electrically coupled to the first voltage end V1 under the control of a first light-emission control signal provided by the first light-emission control end E1; and a source electrode of a transistor included in the first light-emission control circuit 11 is electrically coupled to the first voltage end V1.

In at least one embodiment of the present disclosure, the first voltage end V1 is, but not limited to, a low voltage end.

In the related art, the first light-emission control circuit 11 is arranged between the light-emitting element E0 and the driving circuit 10, and a voltage applied to the source electrode of the transistor included in the first light-emission control circuit 11 is variable, so a signal applied to a gate electrode of the transistor included in the first light-emission control circuit 11 needs a relatively large voltage difference. Based on this, in at least one embodiment of the present disclosure, the first light-emission control circuit 11 is arranged between the light-emitting element E0 and the first voltage end V1, and a type of the transistor included in the first light-emission control circuit 11 is set in such a manner that a source electrode of the transistor is electrically coupled to a direct-current voltage end (the first voltage end V1 is the direct-current voltage end), so as to narrow a range of a voltage applied to a gate electrode of the transistor. An on state and an off state of the voltage applied to the gate electrode are set with a voltage of a first voltage signal provided by the first voltage end V1 as a center, so as to reduce a risk of signal crosstalk.

In at least one embodiment of the present disclosure, the light-emitting element E0 is, but not limited to, a mini Light-Emitting Diode (LED) or a micro LED. During the implementation, the light-emitting element E0 may also be a light-emitting element of any other type, e.g., an Organic Light-Emitting Diode (OLED).

The mini LED and the micro LED have a characteristic of self-luminescence, and they have such advantages as high brightness, low power consumption, small volume, super high resolution, super high color saturation. The micro LED is made of an inorganic material, and it is absolutely advantageous over the OLED which also has a characteristic of self-luminescence in terms of optical performance. The micro LED has high luminous efficiency and a long service life, the material of the micro LED is insusceptible to an environment, and such a phenomenon as afterimage is avoided. Currently, a Pulse Width Modulation (PWM) technology is adopted by a driving circuit in a display device using the mini LED or micro LED, so as to solve the problem that the mini LED or micro LED has low luminous efficiency at a low current density and there is a large brightness difference between the light-emitting elements, and prevent the occurrence of flickering through the introduction of high-frequency PWM.

In the related art, for a PWM circuit into which a system-wide high-frequency signal shf is introduced, the system-wide high-frequency signal Shf is distributed in an entire display region, and a voltage amplitude of Shf is relatively large, so there is a serious coupling influence on a driving back plate. At this time, a voltage applied to an important pixel node is interfered, display quality is adversely affected, and the logic power consumption is also very high. In at least one embodiment of the present disclosure, it is able to effectively reduce the voltage amplitude of the system-wide high-frequency signal Shf, reduce the coupling influence of the system-wide high-frequency signal Shf on the driving back plate, and reduce the interference of Shf on the voltage applied to the important pixel node, thereby to improve the display quality, and reduce the logic power consumption.

As shown in FIG. 2, in at least one embodiment of the present disclosure, the pixel circuit further includes a second light-emission control circuit 20; the second light-emission control circuit 20 is electrically coupled to a second light-emission control end E2, a second voltage end V2 and a first end of the driving circuit 10, and configured to control the second voltage end V2 to be electrically coupled to the first end of the driving circuit 10 under the control of a second light-emission control signal provided by the second light-emission control end E2; a source electrode of a transistor included in the second light-emission control circuit 20 is electrically coupled to the second voltage end V2; and a second end of the driving circuit is electrically coupled to the first electrode of the light-emitting element.

During the implementation, the pixel circuit further includes the second light-emission control circuit 20, the second light-emission control circuit 20 controls the second voltage end V2 to be electrically coupled to the first end of the driving circuit 10 under the control of the second light-emission control signal, and the second voltage end V2 is a direct-current voltage end. Through setting a type of the transistor included in the second light-emission control circuit, the source electrode of the transistor included in the second light-emission control circuit 20 is electrically coupled to the second voltage end V2, so as to narrow a range of a voltage applied to a gate electrode of the transistor included in the second light-emission control circuit 20. An on state and an off state of the voltage applied to the gate electrode are set with a voltage of a second voltage signal provided by the second voltage end V2 as a center, so as to reduce a risk of signal crosstalk.

Optionally, the first light-emission control circuit includes a first transistor; a gate electrode of the first transistor is electrically coupled to the first light-emission control end, a first electrode of the first transistor is electrically coupled to the second electrode of the light-emitting element, and a second electrode of the first transistor is electrically coupled to the first voltage end; and the first transistor is an n-type transistor.

Optionally, the second light-emission control circuit includes a second transistor; a gate electrode of the second transistor is electrically coupled to the second light-emission control end, a first electrode of the second transistor is electrically coupled to the second voltage end, and a second electrode of the second transistor is electrically coupled to the first end of the driving circuit; and the second transistor is a p-type transistor.

In at least one embodiment of the present disclosure, the pixel circuit further includes a third light-emission control circuit; the third light-emission control circuit is electrically coupled to the first light-emission control end, a first data line, a first write-in control end, a third voltage end, a fourth voltage end, a first light-emission control voltage end and a second light-emission control voltage end, and configured to write a first data voltage provided by the first data line into a first light-emission control node under the control of a first write-in control signal provided by the first write-in control end, maintain a potential at the first light-emission control node, and control the first light-emission control end to be electrically coupled to the first light-emission control voltage end or the second light-emission control voltage end under the control of the first data voltage.

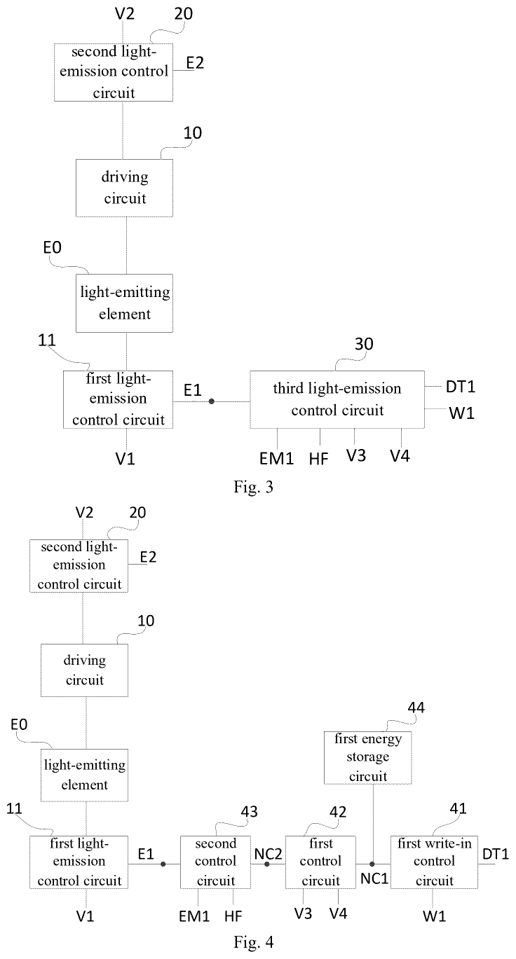

As shown in FIG. 3, on the basis of the driving circuit in FIG. 2, the pixel circuit further includes the third light-emission control circuit. The third light-emission control circuit writes the first data voltage into the first light-emission control node under the control of the first write-in control signal, and controls the first light-emission control end to be electrically coupled to the first light-emission control voltage end or the second light-emission control voltage end under the control of the first data voltage.

As shown in FIG. 3, on the basis of the driving circuit in FIG. 2, the pixel circuit further includes a third light-emission control circuit 30; the third light-emission control circuit 30 is electrically coupled to the first light-emission control end E1, a first data line DT1, a first write-in control end W1, a third voltage end V3, a fourth voltage end V4, a first light-emission control voltage end EM1 and a second light-emission control voltage end HF, and configured to write a first data voltage Vdata1 provided by the first data line DT1 into a first light-emission control node NC1 under the control of a first write-in control signal provided by the first write-in control end W1, maintain a potential at the first light-emission control node NC1, and control the first light-emission control end E1 to be electrically coupled to the first light-emission control voltage end EM1 or the second light-emission control voltage end HF under the control of the first data voltage Vdata1.

In at least one embodiment of the present disclosure, the third voltage end V3 is a low level end, and the fourth voltage end V3 is a high level end.

In at least one embodiment of the present disclosure, the second light-emission control end HF is used to provide a system-wide high-frequency signal Shf.

In at least one embodiment of the present disclosure, the third light-emission control circuit includes a first write-in control circuit, a first control circuit, a second control circuit and a first energy storage circuit; the first write-in control circuit is electrically coupled to the first write-in control end, the first data line and the first light-emission control node, and configured to write the first data voltage into the first light-emission control node under the control of the first write-in control signal; the first energy storage circuit is electrically coupled to the first light-emission control node, and configured to maintain the potential at the first light-emission control node; the first control circuit is electrically coupled to the first light-emission control node, the third voltage end, the fourth voltage end and a second light-emission control node, and configured to control the second light-emission control node to be electrically coupled to the third voltage end or the fourth voltage end under the control of the potential at the first light-emission control node; and the second control circuit is electrically coupled to the second light-emission control node, the first light-emission control end, the first light-emission control voltage end and the second light-emission control voltage end, and configured to control the first light-emission control end to be electrically coupled to the first light-emission control voltage end or the second light-emission control voltage end under the control of a potential at the second light-emission control node.

During the implementation, the third light-emission control circuit includes the first write-in control circuit, the first control circuit, the second control circuit and the first energy storage circuit. The first write-in control circuit writes the first data voltage into the first light-emission control node under the control of the first write-in control signal. The first energy storage circuit maintains the potential at the first light-emission control node. The first control circuit controls the second light-emission control node to be electrically coupled to the third voltage end or the fourth voltage end under the control of the potential at the first light-emission control node. The second control circuit controls the first light-emission control end to be electrically coupled to the first light-emission control voltage end or the second light-emission control voltage end under the control of the potential at the second light-emission control node.

As shown in FIG. 4, on the basis of the driving circuit in FIG. 3, the third light-emission control circuit includes a first write-in control circuit 41, a first control circuit 42, a second control circuit 43 and a first energy storage circuit 44.

The first write-in control circuit 41 is electrically coupled to the first write-in control end W1, the first data line DT1 and the first light-emission control node NC1, and configured to write the first data voltage Vdata1 into the first light-emission control node NC1 under the control of the first write-in control signal.

The first energy storage circuit 44 is electrically coupled to the first light-emission control node NC1, and configured to maintain the potential at the first light-emission control node NC1.

The first control circuit 42 is electrically coupled to the first light-emission control node NC1, the third voltage end V3, the fourth voltage end V4 and a second light-emission control node NC2, and configured to control the second light-emission control node NC2 to be electrically coupled to the third voltage end V3 or the fourth voltage end V4 under the control of the potential at the first light-emission control node NC1.

The second control circuit 43 is electrically coupled to the second light-emission control node NC2, the first light-emission control end E1, the first light-emission control voltage end EM1 and the second light-emission control voltage end HF, and configured to control the first light-emission control end E1 to be electrically coupled to the first light-emission control voltage end EM1 or the second light-emission control voltage end HF under the control of a potential at the second light-emission control node NC2.

Optionally, the first write-in control circuit includes a third transistor, the first control circuit includes a fourth transistor and a fifth transistor, the second control circuit includes a sixth transistor and a seventh transistor, and the first energy storage circuit includes a first capacitor; a gate electrode of the third transistor is electrically coupled to the first write-in control end, a first electrode of the third transistor is electrically coupled to the first data line, and a second electrode of the third transistor is electrically coupled to the first light-emission control node; a gate electrode of the fourth transistor is electrically coupled to the first light-emission control node, a first electrode of the fourth transistor is electrically coupled to the third voltage end, and a second electrode of the fourth transistor is electrically coupled to the second light-emission control node; a gate electrode of the fifth transistor is electrically coupled to the first light-emission control node, a first electrode of the fifth transistor is electrically coupled to the fourth voltage end, and a second electrode of the fifth transistor is electrically coupled to the second light-emission control node; a gate electrode of the sixth transistor is electrically coupled to the second light-emission control node, a first electrode of the sixth transistor is electrically coupled to the first light-emission control voltage end, and a second electrode of the sixth transistor is electrically coupled to the first light-emission control end; a gate electrode of the seventh transistor is electrically coupled to the second light-emission control node, a first electrode of the seventh transistor is electrically coupled to the second light-emission control voltage end, and a second electrode of the seventh transistor is electrically coupled to the first light-emission control end; and a first end of the first capacitor is electrically coupled to the first light-emission control node, and a second end of the first capacitor is electrically coupled to a first initial voltage end.

In at least one embodiment of the present disclosure, the pixel circuit further includes a fourth light-emission control circuit; the fourth light-emission control circuit is electrically coupled to the second light-emission control end, a first data line, a first write-in control end, a third voltage end, a fourth voltage end, a first light-emission control voltage end and a second light-emission control voltage end, and configured to write a first data voltage provided by the first data line into a first light-emission control node under the control of a first write-in control signal provided by the first write-in control end, maintain a potential at the first light-emission control node, and control the second light-emission control end to be electrically coupled to the first light-emission control voltage end or the second light-emission control voltage end under the control of the first data voltage.

During the implementation, the pixel circuit further includes the fourth light-emission control circuit. The fourth light-emission control circuit writes the first data voltage into the first light-emission control node under the control of the first write-in control signal, maintains the potential at the first light-emission control node, and controls the second light-emission control end to be electrically coupled to the first light-emission control voltage end or the second light-emission control voltage end under the control of the first data voltage.

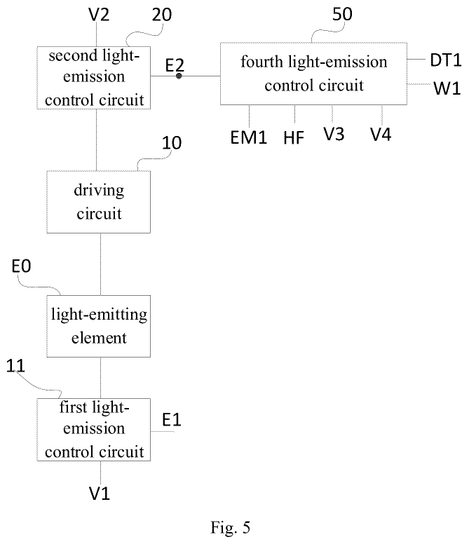

As shown in FIG. 5, on the basis of the pixel circuit in FIG. 2, in at least one embodiment of the present disclosure, the pixel circuit further includes a fourth light-emission control circuit 50. The fourth light-emission control circuit 50 is electrically coupled to the second light-emission control end E2, the first data line DT1, the first write-in control end W1, the third voltage end V3, the fourth voltage end V4, the first light-emission control voltage end EM1 and the second light-emission control voltage end HF, and configured to write the first data voltage Vdata1 provided by the first data line DT1 into the first light-emission control node NC1 under the control of the first write-in control signal provided by the first write-in control end EM1, maintain the potential at the first light-emission control node NC1, and control the second light-emission control end E2 to be electrically coupled to the first light-emission control voltage end EM1 or the second light-emission control voltage end HF2 under the control of the first data voltage.

In at least one embodiment of the present disclosure, the fourth light-emission control circuit includes a first write-in control circuit, a first control circuit, a second control circuit and a first energy storage circuit; the first write-in control circuit is electrically coupled to the first write-in control end, the first data line and the first light-emission control node, and configured to write the first data voltage into the first light-emission control node under the control of the first write-in control signal; the first energy storage circuit is electrically coupled to the first light-emission control node, and configured to maintain the potential at the first light-emission control node; the first control circuit is electrically coupled to the first light-emission control node, the third voltage end, the fourth voltage end and a second light-emission control node, and configured to control the second light-emission control node to be electrically coupled to the third voltage end or the fourth voltage end under the control of the potential at the first light-emission control node; and the second control circuit is electrically coupled to the second light-emission control node, the second light-emission control end, the first light-emission control voltage end and the second light-emission control voltage end, and configured to control the second light-emission control end to be electrically coupled to the first light-emission control voltage end or the second light-emission control voltage end under the control of a potential at the second light-emission control node.

During the implementation, the fourth light-emission control circuit includes the first write-in control circuit, the first control circuit, the second control circuit and the first energy storage circuit. The first write-in control circuit writes the first data voltage into the first light-emission control node under the control of the first write-in control signal. The first energy storage circuit maintains the potential at the first light-emission control node. The first control circuit controls the second light-emission control node to be electrically coupled to the third voltage end or the fourth voltage end under the control of the potential at the first light-emission control node. The second control circuit controls the second light-emission control end to be electrically coupled to the first light-emission control voltage end or the second light-emission control voltage end under the control of the potential at the second light-emission control node.

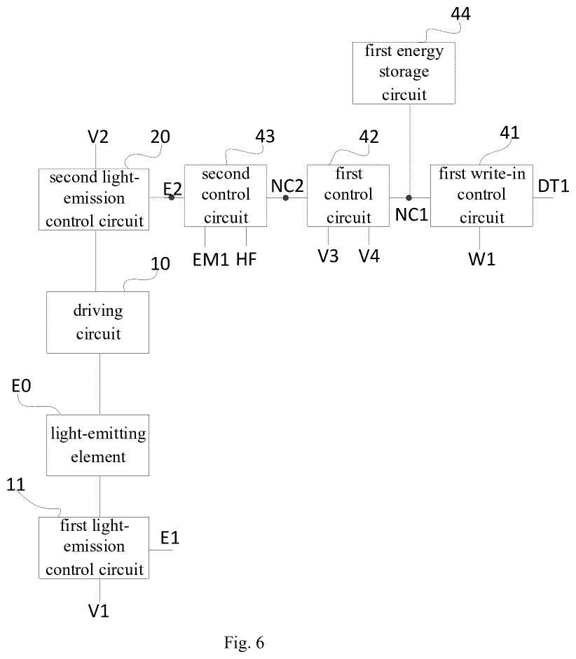

As shown in FIG. 6, on the basis of the pixel circuit in FIG. 5, the fourth light-emission control circuit includes a first write-in control circuit 41, a first control circuit 42, a second control circuit 43 and a first energy storage circuit 44.

The first write-in control circuit 41 is electrically coupled to the first write-in control end W1, the first data line DT1 and the first light-emission control node NC1, and configured to write the first data voltage Vdata1 into the first light-emission control node NC1 under the control of the first write-in control signal.

The first energy storage circuit 44 is electrically coupled to the first light-emission control node NC1, and configured to maintain the potential at the first light-emission control node NC1.

The first control circuit 42 is electrically coupled to the first light-emission control node NC1, the third voltage end V3, the fourth voltage end V4 and the second light-emission control node NC2, and configured to control the second light-emission control node NC2 to be electrically coupled to the third voltage end V3 or the fourth voltage end V4 under the control of the potential at the first light-emission control node NC1.

The second control circuit 43 is electrically coupled to the second light-emission control node NC2, the second light-emission control end E2, the first light-emission control voltage end EM1 and the second light-emission control voltage end HF, and configured to control the second light-emission control end E2 to be electrically coupled to the first light-emission control voltage end EM1 or the second light-emission control voltage end HF under the control of the potential at the second light-emission control node NC2.

Optionally, the first write-in control circuit includes a third transistor, the first control circuit includes a fourth transistor and a fifth transistor, the second control circuit includes a sixth transistor and a seventh transistor, and the first energy storage circuit includes a first capacitor; a gate electrode of the third transistor is electrically coupled to the first write-in control end, a first electrode of the third transistor is electrically coupled to the first data line, and a second electrode of the third transistor is electrically coupled to the first light-emission control node; a gate electrode of the fourth transistor is electrically coupled to the first light-emission control node, a first electrode of the fourth transistor is electrically coupled to the third voltage end, and a second electrode of the fourth transistor is electrically coupled to the second light-emission control node; a gate electrode of the fifth transistor is electrically coupled to the first light-emission control node, a first electrode of the fifth transistor is electrically coupled to the fourth voltage end, and a second electrode of the fifth transistor is electrically coupled to the second light-emission control node; a gate electrode of the sixth transistor is electrically coupled to the second light-emission control node, a first electrode of the sixth transistor is electrically coupled to the first light-emission control voltage end, and a second electrode of the sixth transistor is electrically coupled to the second light-emission control end; a gate electrode of the seventh transistor is electrically coupled to the second light-emission control node, a first electrode of the seventh transistor is electrically coupled to the second light-emission control voltage end, and a second electrode of the seventh transistor is electrically coupled to the second light-emission control end; and a first end of the first capacitor is electrically coupled to the first light-emission control node, and a second end of the first capacitor is electrically coupled to a first initial voltage end.

In at least one embodiment of the present disclosure, the pixel circuit further includes a first resetting circuit; and the first resetting circuit is electrically coupled to a first resetting end, the first electrode of the light-emitting element and the second electrode of the light-emitting element, and configured to control the first electrode of the light-emitting element to be electrically coupled to the second electrode of the light-emitting element under the control of a first resetting signal provided by the first resetting end.

During the implementation, the pixel circuit further includes the first resetting circuit, and the first resetting circuit controls the first electrode of the light-emitting element to be electrically coupled to the second electrode of the light-emitting element under the control of the first resetting signal, so as to reset the light-emitting element.

In at least one embodiment of the present disclosure, through a new design of the first resetting circuit, it is unnecessary to introduce an external initial voltage in a case of resetting the light-emitting element. In addition, a transistor included in the first resetting circuit is used as a detection switch in a case that a yield of the driving back plate is tested. During the manufacture of the driving back plate, the light-emitting element is not coupled to the circuit through eutectic bonding, die bonding or mass transfer. Through turning on the transistor included in the first resetting circuit, the pixel circuit operates, so it is able to improve a defect detection rate of the driving back plate.

Optionally, the first resetting circuit includes an eighth transistor; and a gate electrode of the eighth transistor is electrically coupled to the first resetting end, a first electrode of the eighth transistor is electrically coupled to the first electrode of the light-emitting element, and a second electrode of the eighth transistor is electrically coupled to the second electrode of the light-emitting element.

In at least one embodiment of the present disclosure, the pixel circuit further includes a second energy storage circuit, a second write-in control circuit, a compensation control circuit and a second resetting circuit; the second energy storage circuit is electrically coupled to the control end of the driving circuit, and configured to store electric energy; the second write-in control circuit is electrically coupled to a second write-in control end, a second data line and the first end of the driving circuit, and configured to write a second data voltage provided by the second data line into the first end of the driving circuit under the control of a second write-in control signal provided by the second write-in control end; the compensation control circuit is electrically coupled to a compensation control end, the control end of the driving circuit and the second end of the driving circuit, and configured to control the control end of the driving circuit to be electrically coupled to the second end of the driving circuit under the control of a compensation control signal provided by the compensation control end; and the second resetting circuit is electrically coupled to a second resetting end, a second initial voltage end and the control end of the driving circuit, and configured to write a second initial voltage provided by the second initial voltage end into the control end of the driving circuit under the control of a second resetting signal provided by the second resetting end.

During the implementation, the pixel circuit further includes the second energy storage circuit, the second write-in control circuit, the compensation control circuit and the second resetting circuit. The second write-in control circuit writes the second data voltage provided by the second data line into the first end of the driving circuit under the control of the second write-in control signal. The compensation control circuit controls the control end of the driving circuit to be electrically coupled to the second end of the driving circuit under the control of the compensation control signal. The second resetting circuit writes the second initial voltage into the control end of the driving circuit under the control of the second resetting signal.

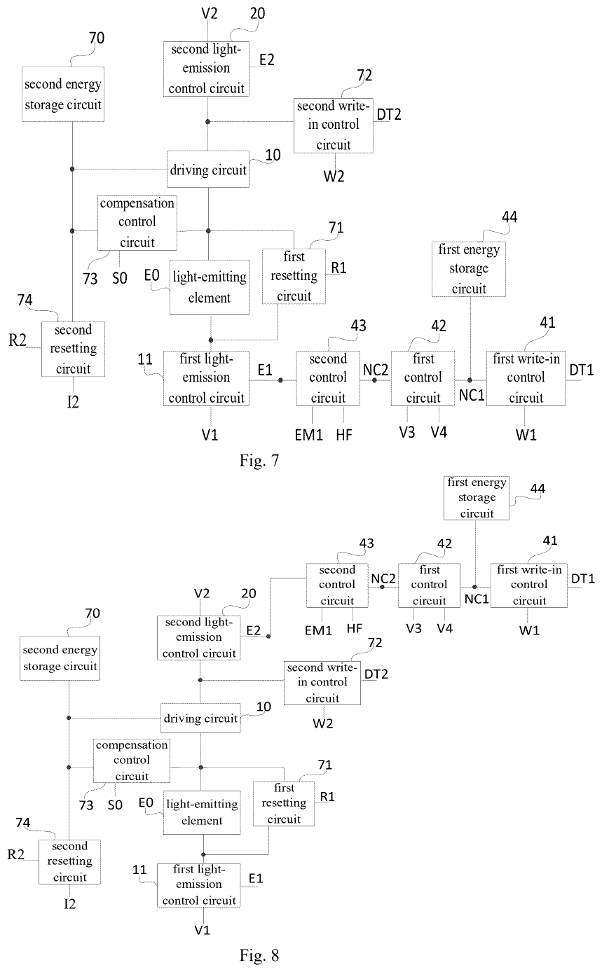

As shown in FIG. 7, on the basis of the driving circuit in FIG. 4, in at least one embodiment of the present disclosure, the driving circuit further includes a second energy storage circuit 70, a first resetting circuit 71, a second write-in control circuit 72, a compensation control circuit 73 and a second resetting circuit 74.

The second energy storage circuit 70 is electrically coupled to the control end of the driving circuit 10, and configured to store electric energy.

The first resetting circuit 71 is electrically coupled to a first resetting end R1, the first electrode of the light-emitting element E0 and the second electrode of the light-emitting element E0, and configured to control the first electrode of the light-emitting element E0 to be electrically coupled to the second electrode of the light-emitting element E0 under the control of a first resetting signal provided by the first resetting end R1.

The second write-in control circuit 72 is electrically coupled to a second write-in control end W2, a second data line DT2 and the first end of the driving circuit 10, and configured to write a second data voltage Vdata2 provided by the second data line DT2 into the first end of the driving circuit 10 under the control of a second write-in control signal provided by the second write-in control end W2.

The compensation control circuit 73 is electrically coupled to a compensation control end S0, the control end of the driving circuit 10 and the second end of the driving circuit 11, and configured to control the control end of the driving circuit 10 to be electrically coupled to the second end of the driving circuit 10 under the control of a compensation control signal provided by the compensation control end S0.

The second resetting circuit 74 is electrically coupled to a second resetting end R2, a second initial voltage end I2 and the control end of the driving circuit 10, and configured to write a second initial voltage Vinit2 provided by the second initial voltage end I2 into the control end of the driving circuit 10 under the control of a second resetting signal provided by the second resetting end R2.

As shown in FIG. 8, on the basis of the driving circuit in FIG. 6, in at least one embodiment of the present disclosure, the driving circuit further includes a second energy storage circuit 70, a first resetting circuit 71, a second write-in control circuit 72, a compensation control circuit 73 and a second resetting circuit 74.

The second energy storage circuit 70 is electrically coupled to the control end of the driving circuit 10, and configured to store electric energy.

The first resetting circuit 71 is electrically coupled to a first resetting end R1, the first electrode of the light-emitting element E0 and the second electrode of the light-emitting element E0, and configured to control the first electrode of the light-emitting element E0 to be electrically coupled to the second electrode of the light-emitting element E0 under the control of a first resetting signal provided by the first resetting end R1.

The second write-in control circuit 72 is electrically coupled to a second write-in control end W2, a second data line DT2 and the first end of the driving circuit 10, and configured to write a second data voltage Vdata2 provided by the second data line DT2 into the first end of the driving circuit 10 under the control of a second write-in control signal provided by the second write-in control end W2.

The compensation control circuit 73 is electrically coupled to a compensation control end S0, the control end of the driving circuit 10 and the second end of the driving circuit 11, and configured to control the control end of the driving circuit 10 to be electrically coupled to the second end of the driving circuit 10 under the control of a compensation control signal provided by the compensation control end S0.

The second resetting circuit 74 is electrically coupled to a second resetting end R2, a second initial voltage end I2 and the control end of the driving circuit 10, and configured to write a second initial voltage Vinit2 provided by the second initial voltage end I2 into the control end of the driving circuit 10 under the control of a second resetting signal provided by the second resetting end R2.

Optionally, the second energy storage circuit includes a second capacitor, the second write-in circuit control circuit includes a ninth transistor, the compensation control circuit includes a tenth transistor, the second resetting circuit includes an eleventh transistor, and the driving circuit includes a driving transistor; a first end of the second capacitor is electrically coupled to a gate electrode of the driving transistor, and a second end of the second capacitor is electrically coupled to the second voltage end; a gate electrode of the ninth transistor is electrically coupled to the second write-in control end, a first electrode of the ninth transistor is electrically coupled to the second data line, and a second electrode of the ninth transistor is electrically coupled to the first end of the driving circuit; a gate electrode of the tenth transistor is electrically coupled to the compensation control end, a first electrode of the tenth transistor is electrically coupled to the control end of the driving circuit, and a second electrode of the tenth transistor is electrically coupled to the second end of the driving circuit; a gate electrode of the eleventh transistor is electrically coupled to the second resetting end, a first electrode of the eleventh transistor is electrically coupled to the second initial voltage end, and a second electrode of the eleventh transistor is electrically coupled to the control end of the driving circuit; and the gate electrode of the driving transistor is electrically coupled to the control end of the driving circuit, a first electrode of the driving transistor is electrically coupled to the first end of the driving circuit, and a second electrode of the driving transistor is electrically coupled to the second end of the driving circuit.

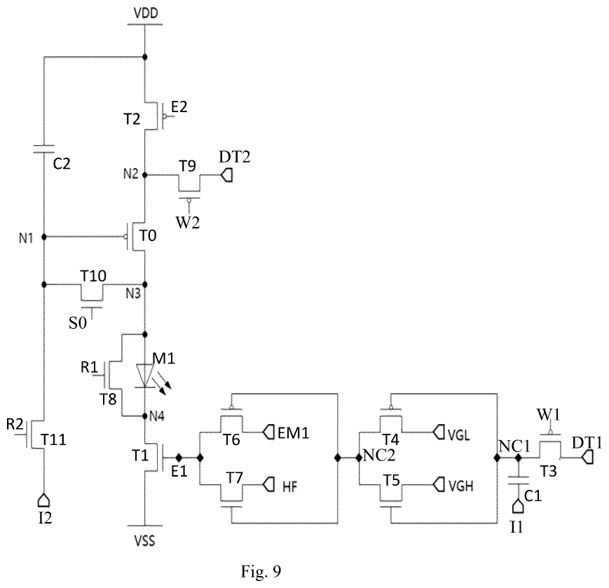

As shown in FIG. 9, on the basis of the pixel circuit in FIG. 7, the driving circuit includes a driving transistor T0, and the light-emitting element is a micro LED M1.

The first light-emission control circuit includes a first transistor T1. A gate electrode of the first transistor T1 is electrically coupled to the first light-emission control end E1, a drain electrode of the first transistor T1 is electrically coupled to a cathode of the micro LED M1, and a source electrode of the first transistor T1 is electrically coupled to a low voltage end VSS. The first transistor T1 is an n-type transistor.

The second light-emission control circuit includes a second transistor T2. A gate electrode of the second transistor T2 is electrically coupled to the second light-emission control end E2, a source electrode of the second transistor T2 is electrically coupled to a high voltage end VDD, and a drain electrode of the second transistor T2 is electrically coupled to a source electrode of the driving transistor T0. The second transistor T2 is a p-type transistor.

The first write-in control circuit includes a third transistor T3, the first control circuit includes a fourth transistor T4 and a fifth transistor T5, the second control circuit includes a sixth transistor T6 and a seventh transistor T7, and the first energy storage circuit includes a first capacitor C1. A gate electrode of the third transistor T3 is electrically coupled to the first write-in control end W1, a source electrode of the third transistor T3 is electrically coupled to the first data line DT1, and a drain electrode of the third transistor T3 is electrically coupled to the first light-emission control node NC1. A gate electrode of the fourth transistor T4 is electrically coupled to the first light-emission control node NC1, a source electrode of the fourth transistor T4 is electrically coupled to a low level end VGL, and a drain electrode of the fourth transistor T4 is electrically coupled to the second light-emission control node NC2. A gate electrode of the fifth transistor T5 is electrically coupled to the first light-emission control node NC1, a source electrode of the fifth transistor T5 is electrically coupled to a high level end VGH, and a drain electrode of the fifth transistor T5 is electrically coupled to the second light-emission control node NC2. A gate electrode of the sixth transistor T6 is electrically coupled to the second light-emission control node NC2, a source electrode of the sixth transistor T6 is electrically coupled to the first light-emission control voltage end EM1, and a drain electrode of the sixth transistor T6 is electrically coupled to the first light-emission control end E1. A gate electrode of the seventh transistor T7 is electrically coupled to the second light-emission control node NC2, a source electrode of the seventh transistor T7 is electrically coupled to the second light-emission control voltage end HF, and a drain electrode of the seventh transistor T7 is electrically coupled to the first light-emission control end E1. A first end of the first capacitor C1 is electrically coupled to the first light-emission control node NC1, a second end of the first capacitor C1 is electrically coupled to a first initial voltage end I1, and the first initial voltage end I1 is configured to provide a first initial voltage Vinit.

The first resetting circuit includes an eighth transistor T8. A gate electrode of the eighth transistor T8 is electrically coupled to the first resetting end R1, a source electrode of the eighth transistor T8 is electrically coupled to an anode of the micro LED M1, and a drain electrode of the eighth transistor T8 is electrically coupled to the cathode of the micro LED M1.

The second energy storage circuit includes a second capacitor C2, the second write-in control circuit includes a ninth transistor T9, the compensation control circuit includes a tenth transistor T10, and the second resetting circuit includes an eleventh transistor T11. A first end of the second capacitor C2 is electrically coupled to a gate electrode of the driving transistor T0, and a second end of the second capacitor C2 is electrically coupled to the high voltage end VDD. A gate electrode of the ninth transistor T9 is electrically coupled to the second write-in control end W2, a source electrode of the ninth transistor T9 is electrically coupled to the second data line DT2, and a drain electrode of the ninth transistor T9 is electrically coupled to the source electrode of the driving transistor T0. A gate electrode of the tenth transistor T10 is electrically coupled to the compensation control end S0, a drain electrode of the tenth transistor T10 is electrically coupled to the gate electrode of the driving transistor T0, and a source electrode of the tenth transistor T10 is electrically coupled to a drain electrode of the driving transistor T0. A gate electrode of the eleventh transistor T11 is electrically coupled to the second resetting end R2, a drain electrode of the eleventh transistor T11 is electrically coupled to the second initial voltage end I2, and a source electrode of the eleventh transistor T11 is electrically coupled to the gate electrode of the driving transistor T0.

In the pixel circuit in FIG. 9, a first node N1 is electrically coupled to the gate electrode of T0, a second node N2 is electrically coupled to the source electrode of T0, a third node N3 is electrically coupled to the drain electrode of T0, and a fourth node N4 is electrically coupled to the cathode of M1.

In the pixel circuit in FIG. 9, T1, T10, T11, T8, T4, T5 and T7 are all n-type transistors, and the other transistors are p-type transistors.

In at least one embodiment of the present disclosure, the pixel circuit includes both n-type transistors and p-type transistors, so as to reduce an amplitude range of a voltage applied to the gate electrode of T1 and an amplitude range of a voltage applied to the gate electrode of T2, thereby to reduce a voltage amplitude of the system-wide high-frequency signal Shf in a case that a PWM circuit is introduced.

In the pixel circuit in FIG. 9, T10 and T11 are oxide transistors with a small leakage current Ioff, so as to improve the current leakage at the first node N1 and the third node N3. T9 is a p-type transistor, T10 is an n-type transistor, and the second write-in control signal provided by W2 has a phase reverse to the compensation control signal provided by S0.

During the implementation, T9 and T10 may be both n-type transistors, or p-type transistors. At this time, the gate electrode of T9 and the gate electrode of T10 are electrically coupled to a same control end, so as to reduce the quantity of driving circuits.

In at least one embodiment of the present disclosure, in the pixel circuit, the type of the transistor is selected according to a process capability and stress-induced offset characteristics.

In the related art, due to a vertical manufacture process of the OLED, merely a common cathode or common anode mode is adopted by the pixel circuit, and all the transistors and capacitors are located at one side of the anode. However, in at least one embodiment of the present disclosure, the LED has a flip-chip structure, so that the transistor is arranged between the cathode of the LED and the low voltage end VSS.

In the pixel circuit in FIG. 9, brightness of a pixel driving circuit is measured through T8. During the manufacture of a display panel, the LED is formed in the end, and the transistors and the capacitors are formed before the formation of the LED. At this time, the third node N3 is controlled to be electrically coupled to the fourth node N4 through T8, so as to test the performance of the pixel driving circuit.

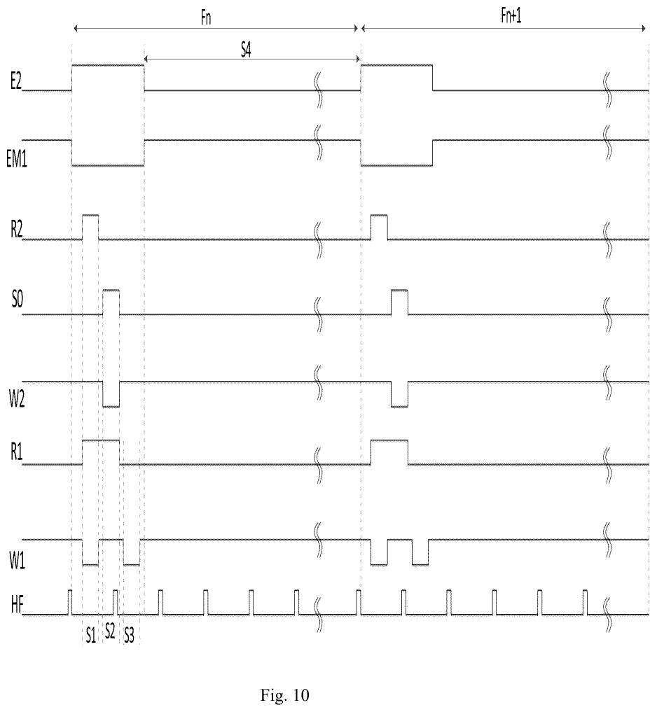

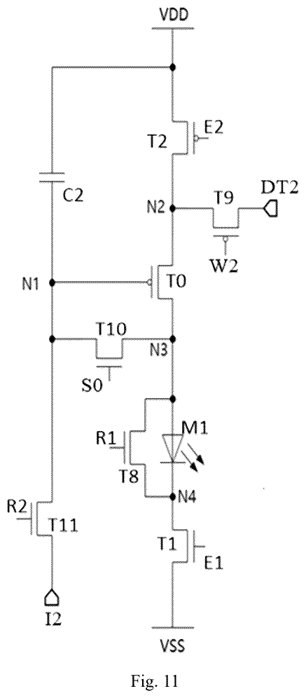

As shown in FIG. 10, during the operation of the pixel circuit in FIG. 9, an nth display time period includes a resetting stage S1, a display data write-in stage S2, a light-emission control data write-in stage S3 and a light-emitting stage S4 arranged sequentially.

At the resetting stage S1, E2 provides a high voltage signal, EM1 provides a low voltage signal, R2 provides a high voltage signal, S0 provides a low voltage signal, W2 provides a high voltage signal, R1 provides a high voltage signal, and W1 provides a low voltage signal. T8 is turned on, and the anode of M1 is electrically coupled to the cathode of M1, so as to reset M1. T2 is turned off, T3 is turned on, DT1 provides the resetting signal to NC1 to reset the potential at NC1, and C1 maintains the potential at NC1. T11 is turned on to write the second initial voltage Vinit2 provided by I2 into the first node N1, so that T0 is turned on at the beginning of the display data write-in stage S2.

At the resetting stage S1, the potential of the resetting signal is a low voltage to turn on T4, the potential of NC2 is a low voltage, T6 is turned on, and E1 is electrically coupled to EM1. At this time, EM1 provides a low voltage signal, so T1 is turned off.

At the display data write-in stage S2, E2 provides a high voltage signal, EM1 provides a low voltage signal, R2 provides a low voltage signal, S0 provides a high voltage signal, W2 provides a low voltage signal, R1 provides a high voltage signal, and W1 provides a high voltage signal. T9 is turned on, DT2 provides the second data voltage Vdata2 to the second node N2, Vdata2 is a display data voltage, T10 is turned on, and the first node N1 is electrically coupled to the third node N3. T8 is turned on, and the anode of M1 is electrically coupled to the cathode of M1, so as to reset M1.

At the beginning of the display data write-in stage S2, T0 is turned on, C2 is charged by Vdata2 through T9, T0 and T10 which are in an on state to pull up a potential at the first node N1 until the potential at the first node N1 is Vdata2+Vth, and then T0 is turned off, where Vth is a threshold voltage of T0.

At the light-emission control data write-in stage S4, E2 provides a high voltage signal, EM1 provides a low voltage signal, R2 provides a low voltage signal, S0 provides a low voltage signal, W2 provides a high voltage signal, R1 provides a low voltage signal, and W1 provides a low voltage signal. T3 is turned on, DT1 provides the first data voltage Vdata1 to NC1, and the first data voltage Vdata1 is a light-emission control data voltage.

At the light-emission control data write-in stage S3, in a case that the potential of Vdata1 is a high voltage, the potential at NC1 is a high voltage, C1 maintains the potential at NC1, T5 is turned on, T4 is turned off, NC2 is electrically coupled to the high level end VGH, the potential at NC2 is a high level, T7 is turned on, T6 is turned off, and E1 is electrically coupled to HF. In a case that the potential of Vdata1 is a low voltage, the potential at NC1 is a low voltage, and C1 maintains the potential at NC1. T5 is turned off, T4 is turned on, NC2 is electrically coupled to the low level end VGL, the potential at NC2 is a low voltage, T7 is turned off, T6 is turned on, and E1 is electrically coupled to EM1.

At the light-emitting stage S4, E2 provides a low voltage signal, EM1 provides a high voltage signal, R2 provides a low voltage signal, S0 provides a low voltage signal, W2 provides a high voltage signal, R1 provides a low voltage signal, W1 provides a high voltage signal, and T2 is turned on.

In a case that the potential of Vdata1 is a high voltage at the light-emission control data write-in stage S3, at the light-emitting stage S5, E1 is electrically coupled to HF, HF provides a high frequency signal. In a case that HF provides a high voltage signal, T1 is turned on. At this time, the pixel circuit displays an image at low brightness. Through setting a duty ratio of the high frequency signal provided by HF, it is able to control a light-emission time of M1. In a case that the potential of Vdata1 is a low voltage at the light-emission control data write-in stage S3, at the light-emitting stage S5, E1 is electrically coupled to EM1, and T1 is turned on. At this time, the pixel circuit displays an image at high brightness.

In FIGS. 10, 12 and 14, Fn represents the n^{th} display time period, and Fn+1 represents an (n+1)^{th} display time period, where n is a positive integer.

The pixel circuit in FIG. 11 differs from the pixel circuit in FIG. 9 in that the pixel circuit does not include T3, T4, T5, T6, T7 and C1, and the gate electrode of T1 is electrically coupled to the first light-emission control end E1.

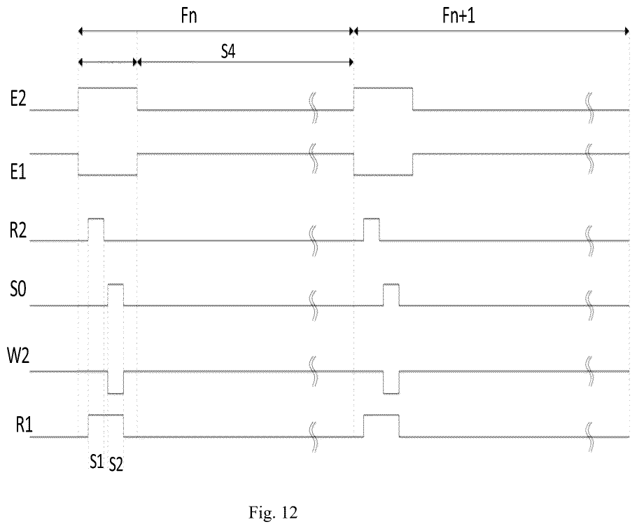

As shown in FIG. 12, during the operation of the pixel circuit in FIG. 11, an nth display time period includes a resetting stage S1, a display data write-in stage S2 and a light-emitting stage S4 arranged sequentially.

At the resetting stage S1, E2 provides a high voltage signal, E1 provides a low voltage signal, R2 provides a high voltage signal, S0 provides a low voltage signal, W2 provides a high voltage signal, and R1 provides a high voltage signal. T8 is turned on, and the anode of M1 is electrically coupled to the cathode of M1, so as to reset M1. T11 is turned on to write the second initial voltage Vinit2 provided by I2 into the first node N1, so that T0 is turned on at the beginning of the display data write-in stage S2.

At the display data write-in stage S2, E2 provides a high voltage signal, E1 provides a low voltage signal, R2 provides a low voltage signal, S0 provides a high voltage signal, W2 provides a low voltage signal, and R1 provides a high voltage signal. T9 is turned on, DT2 provides the second data voltage Vdata2 to the second node N2, Vdata2 is a display data voltage, T10 is turned on, and the first node N1 is electrically coupled to the third node N3.

At the beginning of the display data write-in stage S2, T0 is turned on, C2 is charged by Vdata2 through T9, T0 and T10 which are in an on state to pull up the potential at the first node N1 until the potential at the first node N1 is Vdata2+Vth, and then T0 is turned off, where Vth represents the threshold voltage of T0.

At the light-emitting stage S4, E2 provides a low voltage signal, E1 provides a high voltage signal, R2 provides a low voltage signal, S0 provides a low voltage signal, W2 provides a high voltage signal, R1 provides a low voltage signal, T1 and T2 are turned on, T8 is turned off, and T0 drives M1 to emit light.

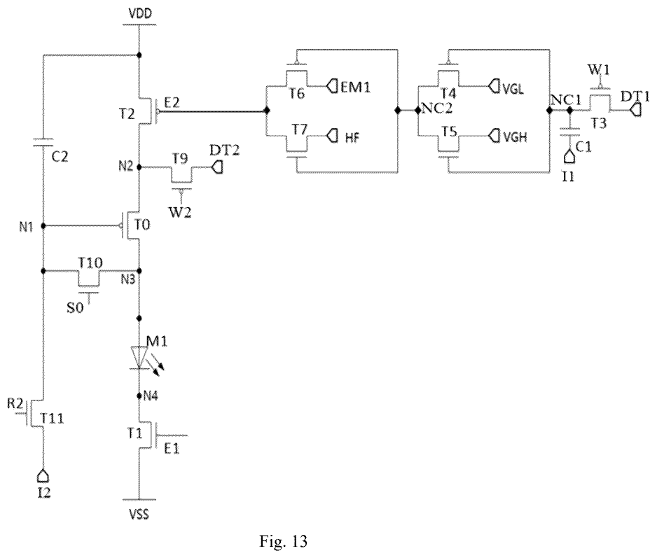

As shown in FIG. 13, on the basis of the pixel circuit in FIG. 8, the driving circuit includes a driving transistor T0, and the light-emitting element is a micro LED M1.

The first light-emission control circuit includes a first transistor T1. A gate electrode of the first transistor T1 is electrically coupled to the first light-emission control end E1, a drain electrode of the first transistor T1 is electrically coupled to a cathode of the micro LED M1, and a source electrode of the first transistor T1 is electrically coupled to a low voltage end VSS. The first transistor T1 is an n-type transistor.

The second light-emission control circuit includes a second transistor T2. A gate electrode of the second transistor T2 is electrically coupled to the second light-emission control end E2, a source electrode of the second transistor T2 is electrically coupled to a high voltage end VDD, and a drain electrode of the second transistor T2 is electrically coupled to a source electrode of the driving transistor T0. The second transistor T2 is a p-type transistor.

The first write-in control circuit includes a third transistor T3, the first control circuit includes a fourth transistor T4 and a fifth transistor T5, the second control circuit includes a sixth transistor T6 and a seventh transistor T7, and the first energy storage circuit includes a first capacitor C1. A gate electrode of the third transistor T3 is electrically coupled to the first write-in control end W1, a source electrode of the third transistor T3 is electrically coupled to the first data line DT1, and a drain electrode of the third transistor T3 is electrically coupled to the first light-emission control node NC1. A gate electrode of the fourth transistor T4 is electrically coupled to the first light-emission control node NC1, a source electrode of the fourth transistor T4 is electrically coupled to a low level end VGL, and a drain electrode of the fourth transistor T4 is electrically coupled to the second light-emission control node NC2. A gate electrode of the fifth transistor T5 is electrically coupled to the first light-emission control node NC1, a source electrode of the fifth transistor T5 is electrically coupled to a high level end VGH, and a drain electrode of the fifth transistor T5 is electrically coupled to the second light-emission control node NC2. A gate electrode of the sixth transistor T6 is electrically coupled to the second light-emission control node NC2, a source electrode of the sixth transistor T6 is electrically coupled to the first light-emission control voltage end EM1, and a drain electrode of the sixth transistor T6 is electrically coupled to the second light-emission control end E2. A gate electrode of the seventh transistor T7 is electrically coupled to the second light-emission control node NC2, a source electrode of the seventh transistor T7 is electrically coupled to the second light-emission control voltage end HF, and a drain electrode of the seventh transistor T7 is electrically coupled to the second light-emission control end E2. A first end of the first capacitor C1 is electrically coupled to the first light-emission control node NC1, a second end of the first capacitor C1 is electrically coupled to the first initial voltage end I1, and the first initial voltage end I1 is configured to provide a first initial voltage Vinit.

The second energy storage circuit includes a second capacitor C2, the second write-in control circuit includes a ninth transistor T9, the compensation control circuit includes a tenth transistor T10, and the second resetting circuit includes an eleventh transistor T11. A first end of the second capacitor C2 is electrically coupled to a gate electrode of the driving transistor T0, and a second end of the second capacitor C2 is electrically coupled to the high voltage end VDD. A gate electrode of the ninth transistor T9 is electrically coupled to the second write-in control end W2, a source electrode of the ninth transistor T9 is electrically coupled to the second data line DT2, and a drain electrode of the ninth transistor T9 is electrically coupled to the source electrode of the driving transistor T0. A gate electrode of the tenth transistor T10 is electrically coupled to the compensation control end S0, a drain electrode of the tenth transistor T10 is electrically coupled to the gate electrode of the driving transistor T0, and a source electrode of the tenth transistor T10 is electrically coupled to a drain electrode of the driving transistor T0. A gate electrode of the eleventh transistor T11 is electrically coupled to the second resetting end R2, a drain electrode of the eleventh transistor T11 is electrically coupled to the second initial voltage end I2, and a source electrode of the eleventh transistor T11 is electrically coupled to the gate electrode of the driving transistor T0.

In the pixel circuit in FIG. 13, the first node N1 is electrically coupled to the gate electrode of T0, the second node N2 is electrically coupled to the source electrode of T0, the third node N3 is electrically coupled to the drain electrode of T0, and the fourth node N4 is electrically coupled to the cathode of M1.

In the pixel circuit in FIG. 13, T1, T10, T11, T4, T5 and T7 are all n-type transistors, and the other transistors are p-type transistors.

In at least one embodiment of the present disclosure, the pixel circuit includes both n-type transistors and p-type transistors, so as to reduce an amplitude range of a voltage applied to the gate electrode of T1 and an amplitude range of a voltage applied to the gate electrode of T2, thereby to reduce a voltage amplitude of the system-wide high-frequency signal Shf in a case that a PWM circuit is introduced.

In the pixel circuit in FIG. 13, T10 and T11 are oxide transistors with a small leakage current Ioff, so as to improve the current leakage at the first node N1 and the third node. T9 is a p-type transistor, T10 is an n-type transistor, and the second write-in control signal provided by W2 has a phase reverse to the compensation control signal provided by S0.

During the implementation, T9 and T10 may be both n-type transistors, or p-type transistors. At this time, the gate electrode of T9 and the gate electrode of T10 are electrically coupled to a same control end, so as to reduce the quantity of driving circuits.

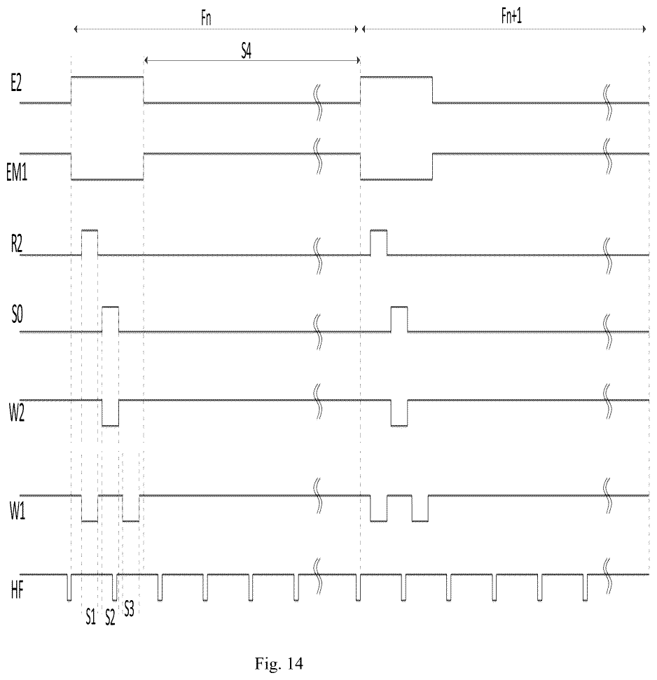

As shown in FIG. 14, during the operation of the pixel circuit in FIG. 13, an nth display time period Fn includes a resetting stage S1, a display data write-in stage S2, a light-emission control data write-in stage S3 and a light-emitting stage S4 arranged sequentially.

At the resetting stage S1, EM1 provides a high voltage signal, E1 provides a low voltage signal, R2 provides a high voltage signal, S0 provides a low voltage signal, W2 provides a high voltage signal, and W1 provides a low voltage signal. T3 is turned on, DT1 provides the resetting signal to NC1 to reset the potential at NC1, and C1 maintains the potential at NC1. T11 is turned on to write the second initial voltage Vinit2 provided by 12 into the first node N1, so that T0 is turned on at the beginning of the display data write-in stage S2.

At the resetting stage S1, the potential of the resetting signal is a low voltage to turn on T4, the potential at NC2 is a low voltage, T6 is turned on, and E2 is electrically coupled to EM1. At this time, EM1 provides a high voltage signal, so T2 is turned off.

At the display data write-in stage S2, EM1 provides a high voltage signal, E1 provides a low voltage signal, R2 provides a low voltage signal, S0 provides a high voltage signal, W2 provides a low voltage signal, and W1 provides a high voltage signal. T9 is turned on, DT2 provides the second data voltage Vdata2 to the second node N2, Vdata2 is a display data voltage, T10 is turned on, and the first node N1 is electrically coupled to the third node N3.

At the beginning of the display data write-in stage S2, T0 is turned on, C2 is charged by Vdata2 through T9, T0 and T10 which are in an on state to pull up the potential at the first node N1 until the potential at the first node N1 is Vdata2+Vth, and then T0 is turned off, where Vth is the threshold voltage of T0.

At the light-emission control data write-in stage S3, EM1 provides a high voltage signal, E1 provides a low voltage signal, R2 provides a low voltage signal, S0 provides a low voltage signal, W2 provides a high voltage signal, and W1 provides a low voltage signal. T3 is turned on, DT1 provides the first data voltage Vdata1 to NC1, and the first data voltage Vdata1 is a light-emission control data voltage.

At the light-emission control data write-in stage S3, in a case that the potential of Vdata1 is a high voltage, the potential at NC1 is a high voltage, C1 maintains the potential at NC1, T5 is turned on, T4 is turned off, NC2 is electrically coupled to the high level end VGH, the potential at NC2 is a high level, T7 is turned on, T6 is turned off, and E2 is electrically coupled to HF. In a case that the potential of Vdata1 is a low voltage, the potential at NC1 is a low voltage, and C1 maintains the potential at NC1. T5 is turned off, T4 is turned on, NC2 is electrically coupled to the low level end VGL, the potential at NC2 is a low voltage, T7 is turned off, T6 is turned on, and E2 is electrically coupled to EM1.

At the light-emitting stage S4, EM1 provides a low voltage signal, E1 provides a high voltage signal, R2 provides a low voltage signal, SO provides a low voltage signal, W2 provides a high voltage signal, W1 provides a high voltage signal, and T1 is turned on.

In a case that the potential of Vdata1 is a high voltage at the light-emission control data write-in stage S3, at the light-emitting stage S5, E2 is electrically coupled to HF, and HF provides a high frequency signal. In a case that HF provides a high voltage signal, T2 is turned on. At this time, the pixel circuit displays an image at low brightness. Through setting a duty ratio of the high frequency signal provided by HF, it is able to control a light-emission time of M1. In a case that the potential of Vdata1 is a low voltage at the light-emission control data write-in stage S3, at the light-emitting stage S5, E2 is electrically coupled to EM1, T2 is turned on, and at this time, the pixel circuit displays an image at high brightness.

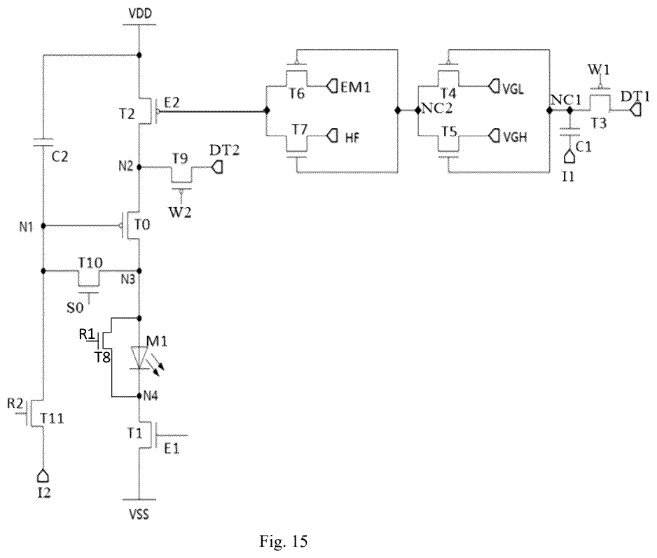

The pixel circuit in FIG. 15 differs from the pixel circuit in FIG. 13 in that the pixel circuit further includes an eighth transistor T8. A gate electrode of the eighth transistor T8 is electrically coupled to the first resetting end R1, a source electrode of the eighth transistor T8 is electrically coupled to the anode of the micro LED M1, and a drain electrode of the eighth transistor T8 is electrically coupled to the cathode of the micro LED M1. T8 is an n-type transistor.

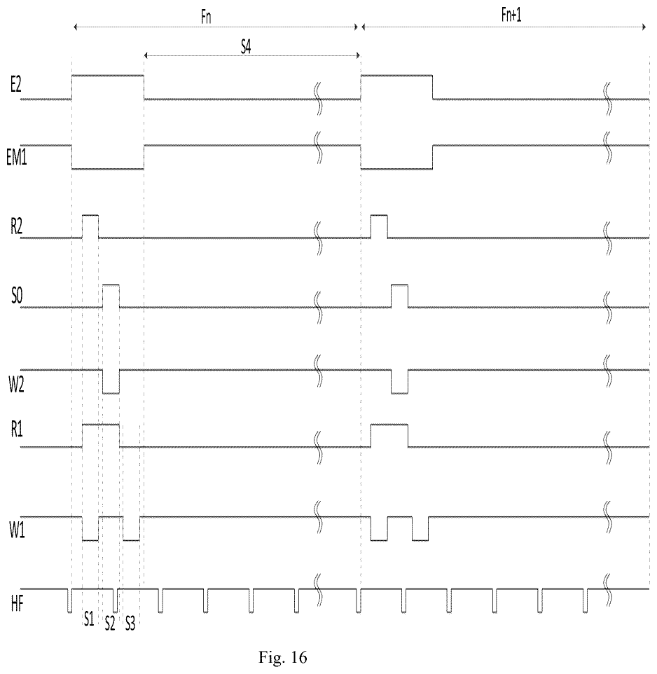

As shown in FIG. 16, during the operation of the pixel circuit in FIG. 15, an nth display time period Fn includes a resetting stage S1, a display data write-in stage S2, a light-emission control data write-in stage S3 and a light-emitting stage S4 arranged sequentially.

At the resetting stage S1, EM1 provides a high voltage signal, E1 provides a low voltage signal, R2 provides a high voltage signal, S0 provides a low voltage signal, W2 provides a high voltage signal, R1 provides a high voltage signal, and W1 provides a low voltage signal. T3 is turned on, DT1 provides the resetting signal to NC1 to reset the potential at NC1, and C1 maintains the potential at NC1. T11 is turned on to write the second initial voltage Vinit2 provided by I2 into the first node N1, so that T0 is turned on at the beginning of the display data write-in stage S2. T8 is turned on, and the anode of M1 is electrically coupled to the cathode of M1.

At the resetting stage S1, the potential of the resetting signal is a low voltage to turn on T4, the potential at NC2 is a low voltage, T6 is turned on, and E2 is electrically coupled to EM1. At this time, EM1 provides a high voltage signal, so T2 is turned off.

At the display data write-in stage S2, EM1 provides a high voltage signal, E1 provides a low voltage signal, R2 provides a low voltage signal, S0 provides a high voltage signal, R1 provides a high voltage signal, W2 provides a low voltage signal, and W1 provides a high voltage signal. T9 is turned on, DT2 provides the second data voltage Vdata2 to the second node N2, Vdata2 is a display data voltage, T10 is turned on, and the first node N1 is electrically coupled to the third node N3. T8 is turned on, and the anode of M1 is electrically coupled to the cathode of M1.

At the beginning of the display data write-in stage S2, T0 is turned on, C2 is charged by Vdata2 through T9, T0 and T10 which are in an on state to pull up the potential at the first node N1 until the potential at the first node N1 is Vdata2+Vth, and then T0 is turned off, where Vth is the threshold voltage of T0.

At the light-emission control data write-in stage S3, EM1 provides a high voltage signal, E1 provides a low voltage signal, R2 provides a low voltage signal, S0 provides a low voltage signal, R1 provides a low voltage signal, W2 provides a high voltage signal, and W1 provides a low voltage signal. T3 is turned on, DT1 provides the first data voltage Vdata1 to NC1, and the first data voltage Vdata1 is a light-emission control data voltage.

At the light-emission control data write-in stage S3, in a case that the potential of Vdata1 is a high voltage, the potential at NC1 is a high voltage, C1 maintains the potential at NC1, T5 is turned on, T4 is turned off, NC2 is electrically coupled to the high level end VGH, the potential at NC2 is a high level, T7 is turned on, T6 is turned off, and E2 is electrically coupled to HF. In a case that the potential of Vdata1 is a low voltage, the potential at NC1 is a low voltage, and C1 maintains the potential at NC1. T5 is turned off, T4 is turned on, NC2 is electrically coupled to the low level end VGL, the potential at NC2 is a low voltage, T7 is turned off, T6 is turned on, and E2 is electrically coupled to EM1.

At the light-emitting stage S4, EM1 provides a low voltage signal, E1 provides a high voltage signal, R2 provides a low voltage signal, S0 provides a low voltage signal, R1 provides a low voltage signal, W2 provides a high voltage signal, W1 provides a high voltage signal, and T1 is turned on.

In a case that the potential of Vdata1 is a high voltage at the light-emission control data write-in stage S3, at the light-emitting stage S5, E2 is electrically coupled to HF, and HF provides a high frequency signal. In a case that HF provides a high voltage signal, T2 is turned on. At this time, the pixel circuit displays an image at low brightness. Through setting a duty ratio of the high frequency signal provided by HF, it is able to control a light-emission time of M1. In a case that the potential of Vdata1 is a low voltage at the light-emission control data write-in stage S3, at the light-emitting stage S5, E2 is electrically coupled to EM1, T2 is turned on, and at this time, the pixel circuit displays an image at high brightness.

The present disclosure further provides in some embodiments a display device which includes the above-mentioned pixel circuit.

The above are merely the preferred embodiments of the present disclosure. It should be appreciated that, a person skilled in the art may further make improvements and modifications without departing from the principle of the present disclosure, and these improvements and modifications shall also be considered as the scope of the present disclosure.

1. A pixel circuit, comprising a driving circuit, a light-emitting element and a first light-emission control circuit; wherein
the driving circuit is electrically coupled to a first electrode of the light-emitting element, and the driving circuit is configured to generate a driving current for driving the light-emitting element under the control of a potential at a control end of the driving circuit;
the first light-emission control circuit is electrically coupled to a first light-emission control end, a second electrode of the light-emitting element and a first voltage end, and configured to control the second electrode of the light-emitting element to be electrically coupled to the first voltage end under the control of a first light-emission control signal provided by the first light-emission control end; and
a source electrode of a transistor comprised in the first light-emission control circuit is electrically coupled to the first voltage end.

2. The pixel circuit according to claim 1, further comprising a second light-emission control circuit; wherein
the second light-emission control circuit is electrically coupled to a second light-emission control end, a second voltage end and a first end of the driving circuit, and configured to control the second voltage end to be electrically coupled to the first end of the driving circuit under the control of a second light-emission control signal provided by the second light-emission control end;
a source electrode of a transistor comprised in the second light-emission control circuit is electrically coupled to the second voltage end; and
a second end of the driving circuit is electrically coupled to the first electrode of the light-emitting element.

3. The pixel circuit according to claim 1, wherein the first light-emission control circuit comprises a first transistor;
a gate electrode of the first transistor is electrically coupled to the first light-emission control end, a first electrode of the first transistor is electrically coupled to the second electrode of the light-emitting element, and a second electrode of the first transistor is electrically coupled to the first voltage end; and
the first transistor is an n-type transistor.

4. The pixel circuit according to claim 2, wherein the second light-emission control circuit comprises a second transistor;
a gate electrode of the second transistor is electrically coupled to the second light-emission control end, a first electrode of the second transistor is electrically coupled to the second voltage end, and a second electrode of the second transistor is electrically coupled to the first end of the driving circuit; and
the second transistor is a p-type transistor.

5. The pixel circuit according to claim 1, further comprising a third light-emission control circuit; wherein
the third light-emission control circuit is electrically coupled to the first light-emission control end, a first data line, a first write-in control end, a third voltage end, a fourth voltage end, a first light-emission control voltage end and a second light-emission control voltage end, and configured to write a first data voltage provided by the first data line into a first light-emission control node under the control of a first write-in control signal provided by the first write-in control end, maintain a potential at the first light-emission control node, and control the first light-emission control end to be electrically coupled to the first light-emission control voltage end or the second light-emission control voltage end under the control of the first data voltage.

6. The pixel circuit according to claim 5, wherein the third light-emission control circuit comprises a first write-in control circuit, a first control circuit, a second control circuit and a first energy storage circuit;
the first write-in control circuit is electrically coupled to the first write-in control end, the first data line and the first light-emission control node, and configured to write the first data voltage into the first light-emission control node under the control of the first write-in control signal;
the first energy storage circuit is electrically coupled to the first light-emission control node, and configured to maintain the potential at the first light-emission control node;
the first control circuit is electrically coupled to the first light-emission control node, the third voltage end, the fourth voltage end and a second light-emission control node, and configured to control the second light-emission control node to be electrically coupled to the third voltage end or the fourth voltage end under the control of the potential at the first light-emission control node; and
the second control circuit is electrically coupled to the second light-emission control node, the first light-emission control end, the first light-emission control voltage end and the second light-emission control voltage end, and configured to control the first light-emission control end to be electrically coupled to the first light-emission control voltage end or the second light-emission control voltage end under the control of a potential at the second light-emission control node.

7. The pixel circuit according to claim 6, wherein the first write-in control circuit comprises a third transistor, the first control circuit comprises a fourth transistor and a fifth transistor, the second control circuit comprises a sixth transistor and a seventh transistor, and the first energy storage circuit comprises a first capacitor;
a gate electrode of the third transistor is electrically coupled to the first write-in control end, a first electrode of the third transistor is electrically coupled to the first data line, and a second electrode of the third transistor is electrically coupled to the first light-emission control node;
a gate electrode of the fourth transistor is electrically coupled to the first light-emission control node, a first electrode of the fourth transistor is electrically coupled to the third voltage end, and a second electrode of the fourth transistor is electrically coupled to the second light-emission control node;
a gate electrode of the fifth transistor is electrically coupled to the first light-emission control node, a first electrode of the fifth transistor is electrically coupled to the fourth voltage end, and a second electrode of the fifth transistor is electrically coupled to the second light-emission control node;
a gate electrode of the sixth transistor is electrically coupled to the second light-emission control node, a first electrode of the sixth transistor is electrically coupled to the first light-emission control voltage end, and a second electrode of the sixth transistor is electrically coupled to the first light-emission control end;
a gate electrode of the seventh transistor is electrically coupled to the second light-emission control node, a first electrode of the seventh transistor is electrically coupled to the second light-emission control voltage end, and a second electrode of the seventh transistor is electrically coupled to the first light-emission control end; and
a first end of the first capacitor is electrically coupled to the first light-emission control node, and a second end of the first capacitor is electrically coupled to a first initial voltage end.

8. The pixel circuit according to claim 2, further comprising a fourth light-emission control circuit; wherein
the fourth light-emission control circuit is electrically coupled to the second light-emission control end, a first data line, a first write-in control end, a third voltage end, a fourth voltage end, a first light-emission control voltage end and a second light-emission control voltage end, and configured to write a first data voltage provided by the first data line into a first light-emission control node under the control of a first write-in control signal provided by the first write-in control end, maintain a potential at the first light-emission control node, and control the second light-emission control end to be electrically coupled to the first light-emission control voltage end or the second light-emission control voltage end under the control of the first data voltage.

9. The pixel circuit according to claim 8, wherein the fourth light-emission control circuit comprises a first write-in control circuit, a first control circuit, a second control circuit and a first energy storage circuit;
the first write-in control circuit is electrically coupled to the first write-in control end, the first data line and the first light-emission control node, and configured to write the first data voltage into the first light-emission control node under the control of the first write-in control signal;
the first energy storage circuit is electrically coupled to the first light-emission control node, and configured to maintain the potential at the first light-emission control node;
the first control circuit is electrically coupled to the first light-emission control node, the third voltage end, the fourth voltage end and a second light-emission control node, and configured to control the second light-emission control node to be electrically coupled to the third voltage end or the fourth voltage end under the control of the potential at the first light-emission control node; and
the second control circuit is electrically coupled to the second light-emission control node, the second light-emission control end, the first light-emission control voltage end and the second light-emission control voltage end, and configured to control the second light-emission control end to be electrically coupled to the first light-emission control voltage end or the second light-emission control voltage end under the control of a potential at the second light-emission control node.

10. The pixel circuit according to claim 9, wherein the first write-in control circuit comprises a third transistor, the first control circuit comprises a fourth transistor and a fifth transistor, the second control circuit comprises a sixth transistor and a seventh transistor, and the first energy storage circuit comprises a first capacitor;
a gate electrode of the third transistor is electrically coupled to the first write-in control end, a first electrode of the third transistor is electrically coupled to the first data line, and a second electrode of the third transistor is electrically coupled to the first light-emission control node;
a gate electrode of the fourth transistor is electrically coupled to the first light-emission control node, a first electrode of the fourth transistor is electrically coupled to the third voltage end, and a second electrode of the fourth transistor is electrically coupled to the second light-emission control node;
a gate electrode of the fifth transistor is electrically coupled to the first light-emission control node, a first electrode of the fifth transistor is electrically coupled to the fourth voltage end, and a second electrode of the fifth transistor is electrically coupled to the second light-emission control node;
a gate electrode of the sixth transistor is electrically coupled to the second light-emission control node, a first electrode of the sixth transistor is electrically coupled to the first light-emission control voltage end, and a second electrode of the sixth transistor is electrically coupled to the second light-emission control end;
a gate electrode of the seventh transistor is electrically coupled to the second light-emission control node, a first electrode of the seventh transistor is electrically coupled to the second light-Application emission control voltage end, and a second electrode of the seventh transistor is electrically coupled to the second light-emission control end; and
a first end of the first capacitor is electrically coupled to the first light-emission control node, and a second end of the first capacitor is electrically coupled to a first initial voltage end.

11. The pixel circuit according to 10 claim 1, further comprising a first resetting circuit; wherein
the first resetting circuit is electrically coupled to a first resetting end, the first electrode of the light-emitting element and the second electrode of the light-emitting element, and configured to control the first electrode of the light-emitting element to be electrically coupled to the second electrode of the light-emitting element under the control of a first resetting signal provided by the first resetting end.

12. The pixel circuit according to claim 11, wherein the first resetting circuit comprises an eighth transistor; and
a gate electrode of the eighth transistor is electrically coupled to the first resetting end, a first electrode of the eighth transistor is electrically coupled to the first electrode of the light-emitting element, and a second electrode of the eighth transistor is electrically coupled to the second electrode of the light-emitting element.

13. The pixel circuit according to 10 claim 1, further comprising a second energy storage circuit, a second write-in control circuit, a compensation control circuit and a second resetting circuit; wherein
the second energy storage circuit is electrically coupled to the control end of the driving circuit, and configured to store electric energy;
the second write-in control circuit is electrically coupled to a second write-in control end, a second data line and a first end of the driving circuit, and configured to write a second data voltage provided by the second data line into the first end of the driving circuit under the control of a second write-in control signal provided by the second write-in control end;
the compensation control circuit is electrically coupled to a compensation control end, the control end of the driving circuit and a second end of the driving circuit, and configured to control the control end of the driving circuit to be electrically coupled to the second end of the driving circuit under the control of a compensation control signal provided by the compensation control end; and
the second resetting circuit is electrically coupled to a second resetting end, a second initial voltage end and the control end of the driving circuit, and configured to write a second initial voltage provided by the second initial voltage end into the control end of the driving circuit under the control of a second resetting signal provided by the second resetting end.

14. The pixel circuit according to claim 13, wherein the second energy storage circuit comprises a second capacitor, the second write-in circuit control circuit comprises a ninth transistor, the compensation control circuit comprises a tenth transistor, the second resetting circuit comprises an eleventh transistor, and the driving circuit comprises a driving transistor;
a first end of the second capacitor is electrically coupled to a gate electrode of the driving transistor, and a second end of the second capacitor is electrically coupled to a second voltage end;
a gate electrode of the ninth transistor is electrically coupled to the second write-in control end, a first electrode of the ninth transistor is electrically coupled to the second data line, and a second electrode of the ninth transistor is electrically coupled to the first end of the driving circuit;
a gate electrode of the tenth transistor is electrically coupled to the compensation control end, a first electrode of the tenth transistor is electrically coupled to the control end of the driving circuit, and a second electrode of the tenth transistor is electrically coupled to the second end of the driving circuit;
a gate electrode of the eleventh transistor is electrically coupled to the second resetting end, a first electrode of the eleventh transistor is electrically coupled to the second initial voltage end, and a second electrode of the eleventh transistor is electrically coupled to the control end of the driving circuit; and
the gate electrode of the driving transistor is electrically coupled to the control end of the driving circuit, a first electrode of the driving transistor is electrically coupled to the first end of the driving circuit, and a second electrode of the driving transistor is electrically coupled to the second end of the driving circuit.

15. A display device, comprising the pixel circuit according to claim 1.

16. The pixel circuit according to claim 2, further comprising a first resetting circuit; wherein
the first resetting circuit is electrically coupled to a first resetting end, the first electrode of the light-emitting element and the second electrode of the light-emitting element, and configured to control the first electrode of the light-emitting element to be electrically coupled to the second electrode of the light-emitting element under the control of a first resetting signal provided by the first resetting end.

17. The pixel circuit according to claim 3, further comprising a first resetting circuit; wherein
the first resetting circuit is electrically coupled to a first resetting end, the first electrode of the light-emitting element and the second electrode of the light-emitting element, and configured to control the first electrode of the light-emitting element to be electrically coupled to the second electrode of the light-emitting element under the control of a first resetting signal provided by the first resetting end.

18. The pixel circuit according to claim 4, further comprising a first resetting circuit; wherein
the first resetting circuit is electrically coupled to a first resetting end, the first electrode of the light-emitting element and the second electrode of the light-emitting element, and configured to control the first electrode of the light-emitting element to be electrically coupled to the second electrode of the light-emitting element under the control of a first resetting signal provided by the first resetting end.

19. The pixel circuit according to claim 5, further comprising a first resetting circuit; wherein
the first resetting circuit is electrically coupled to a first resetting end, the first electrode of the light-emitting element and the second electrode of the light-emitting element, and configured to control the first electrode of the light-emitting element to be electrically coupled to the second electrode of the light-emitting element under the control of a first resetting signal provided by the first resetting end.

20. The pixel circuit according to claim 6, further comprising a first resetting circuit; wherein
the first resetting circuit is electrically coupled to a first resetting end, the first electrode of the light-emitting element and the second electrode of the light-emitting element, and configured to control the first electrode of the light-emitting element to be electrically coupled to the second electrode of the light-emitting element under the control of a first resetting signal provided by the first resetting end.
